(19) United States
(12) Patent Application Publication
(10) Pub. No.: US 2012/0210596 A1
(43) Pub. Date: Aug. 23, 2012

(54) Sport equipment bag with drying system incorporated therein

(76) Inventor: Denis Lebel, Mascouche (CA)

(21) Appl. No.: 13/369,212

(22) Filed: Feb. 8, 2012

(30) Foreign Application Priority Data
Feb. 22, 2011 (GB) 1103049.1

(51) Int. Cl. F26B 25/06; F26B 9/06; F26B 21/10; A45C 5/00; A45C 15/00

(52) U.S. Cl. 34/524; 206/315.1; 34/202

(57) ABSTRACT

A sport equipment bag with drying system incorporated therein has a flexible shell defining an environmentally controlled interior space having a bottom portion, side wall portions, and a top portion. A sealable opening within the top portion adapted to allow sports equipment to be placed within and taken out from the interior space. An opening within one of the side wall portions adapted to allow environmentally controlled air to be placed within and taken from the interior space. An opening cover attached adjacent to the side wall opening and adapted to cover and seal the side wall opening when not in use. A grid floor member attached to at least one of the side wall portions and suspended above the bottom portion forming a gap therebetween, and including a plurality of holes therein; and at least one elongated support member adapted to fit within any one of the holes of the grid floor member and is adapted to extend between the bottom portion and the top portion and thereby support the top portion.

### FIELD OF THE INVENTION

The present invention relates generally to luggage but more particularly to a sport equipment bag with incorporated drying system.

### BACKGROUND OF THE INVENTION

There are many types of sports bags and there are also many types of luggage which incorporates some features in regards to ventilation or heat generation as well as moisture and water drainage.

### SUMMARY OF THE INVENTION

In view of the foregoing disadvantages inherent in the known devices now present in the prior art, the present invention, which will be described subsequently in greater detail, is to provide objects and advantages which are:

To provide for an integrated luggage system which has ventilation and air purifying features.

In order to do so, the invention consists in a flexible shell defining an environmentally controlled interior space having a bottom portion, side wall portions, and a top portion. A sealable opening within the top portion adapted to allow sports equipment to be placed within and taken out from the interior space. An opening within one of the side wall portions adapted to allow environmentally controlled air to be placed within and taken from the interior space. An opening cover attached adjacent to the side wall opening and adapted to cover and seal the side wall opening when not in use. A grid floor member attached to at least one of the side wall portions and suspended above the bottom portion forming a gap therebetween, and including a plurality of holes therein; and at least one elongated support member adapted to fit within any one of the holes of the grid floor member and is adapted to extend between the bottom portion and the top portion and thereby support the top portion.

In a preferred embodiment, at least one of the side wall portions has an opening in proximity to the gap and is adapted to allow air and liquid to be removed from the interior space.

In another preferred embodiment, at least two side wall portions include a bottom edge molding that is adapted to hold the grid floor member above the bottom portion.

In yet another preferred embodiment, the top portion is formed as an expandable fabric member; and wherein there is a plurality of elongated support members, wherein each of the elongated support member is adapted to be attached to another elongated support member in an end-to-end fashion thereby extending the length of each support member, such that when the top portion is expanded the elongated support members can also be extended and continue to support the top portion in the expanded position.

The sports equipment bag further comprises a pivotable main cover member pivotally connected along an edge of the top portion, such that when in use the main cover member can be pivoted into an open position and the top portion expanded upwards therefrom.

In still another preferred embodiment, the plurality of holes of the grid floor member and the at least one elongated support member have a rectangular cross section, such that the elongated support member cannot rotate when installed within any one of the plurality holes.

In yet another preferred embodiment, an electric fan is placed within the opening within one of the side wall portions, to thereby force environmentally controlled air into the interior space.

The electric fan further includes a heating element and an elongated power cord. The electric fan further includes an ionic air purifier and an elongated power cord.

In still another preferred embodiment, the side wall opening cover is formed as a flexible flap.

In yet another preferred embodiment, the grid floor member extends substantially over the entire surface defined by the bottom portion.

In still another preferred embodiment, a thermostat is attached thereto to monitor and control the interior temperature of the interior space.

In yet another preferred embodiment, at least one exterior pocket is attached to an outer side wall of the side wall portions and each of the at least one pocket having a zipper member to open and enclose.

In still another preferred embodiment, a flexible handle is attached to an outer side wall of the side wall portions.

In yet another preferred embodiment, a retractable handle is attached to an outer side wall of the side wall portions.

In still another preferred embodiment, a plurality of wheels are attached to an outer side wall of either of the side wall portions or the bottom portion.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric partially see through view of the invention.

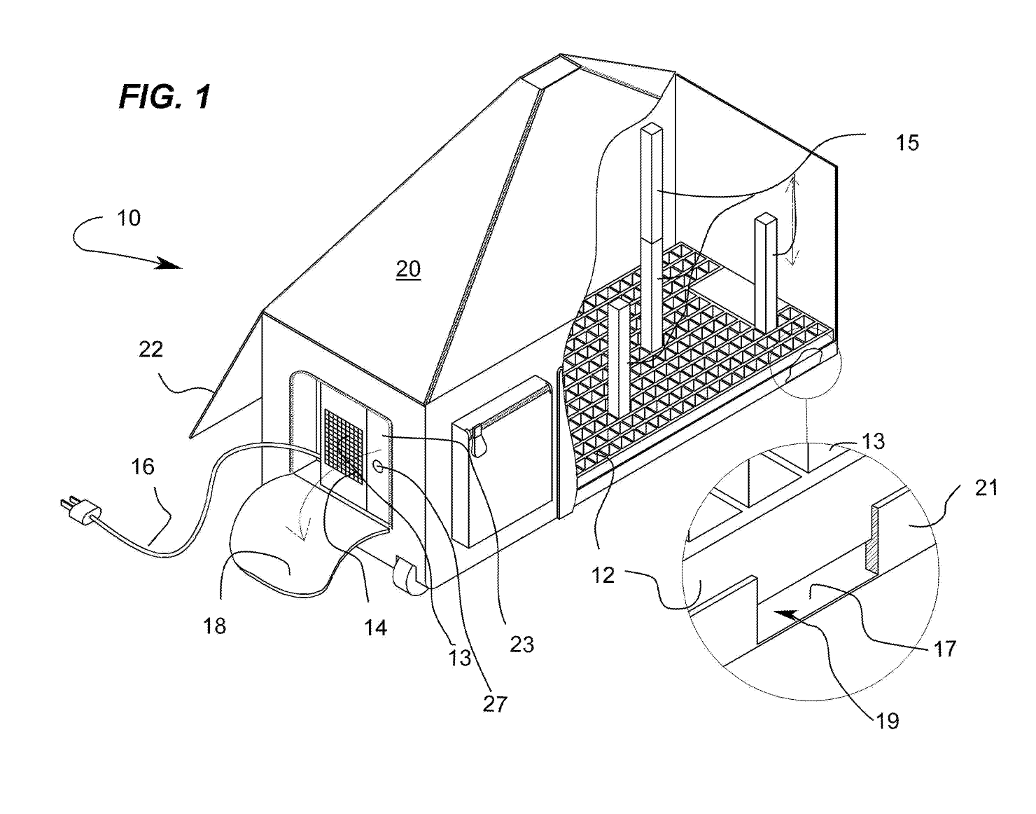

FIGS. 2a-b Isometric views of the invention without and with the expandable top.

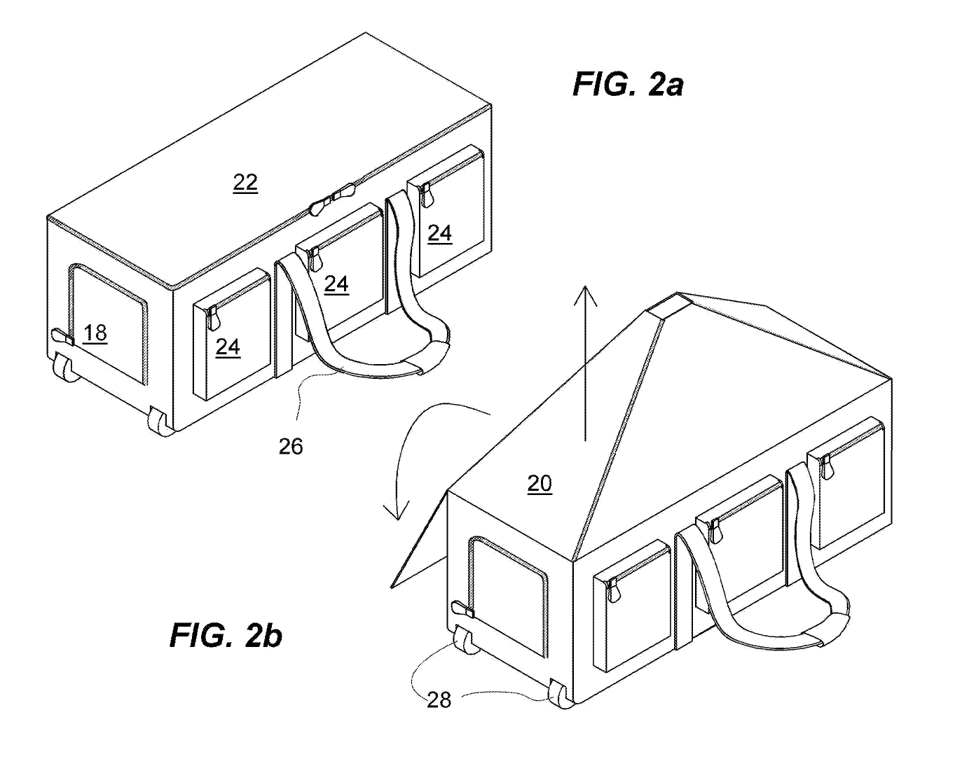

FIG. 3 Isometric view of the invention when using a hair dryer.

FIG. 4 Isometric view with the handle protracted.

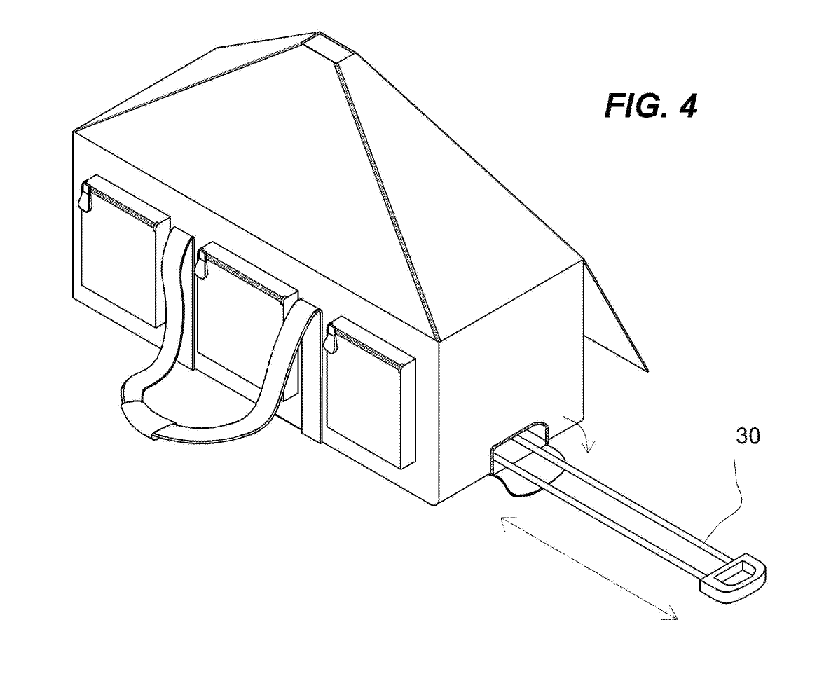

### DETAILED DESCRIPTION OF THE PREFERRED EMBODIMENT

A sport equipment bag (10) with drying system incorporated has a removable raised grid floor member(12) which consists in a grid pattern to allow air to circulate under it and through it by way of a plurality of holes (13). That way, air can run through a gap (19) located between a watertight bottom portion (17), which collects drippings from the equipment inside the bag (10), and the grid floor member (12). The grid floor member (12) is suspended over a bottom edge molding (21) that is adapted to hold the grid floor member (12) above the bottom portion (17). The drippings can then be drained through a drain plug (not shown) as is known in the art of drainage.

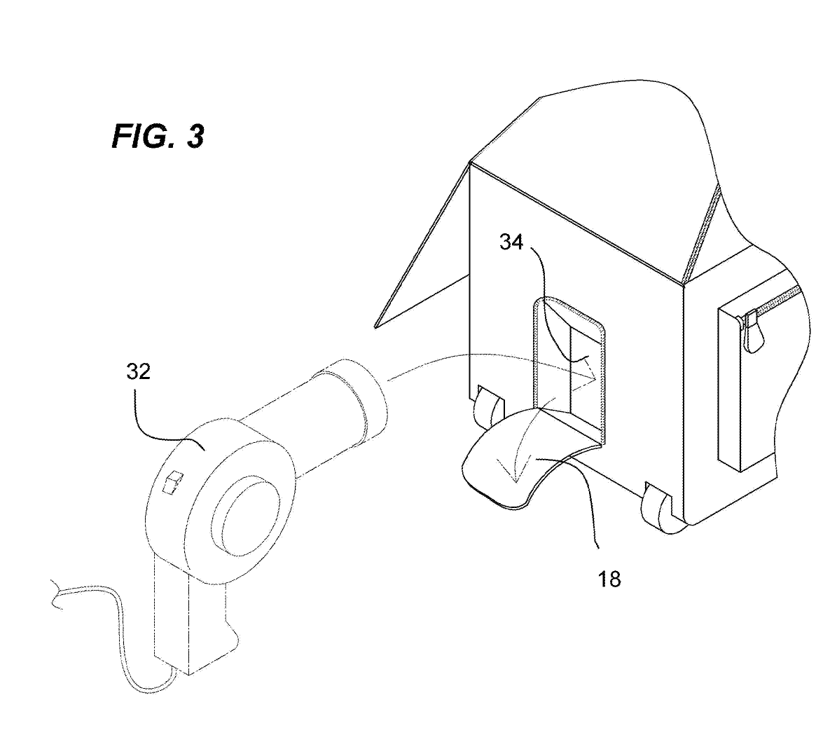

An electric fan (14) with a power cord (16) to circulate air is combined with a heating element (13) for warming the air. The fan (14) is hidden by way of a flap (18). The fan (14) can also be combined with an ionic air purifying system (23). An adjustable thermostat (27) regulates air temperature. Alternatively, a hair dryer (32) can be used instead of the fan (14) as shown in FIG. 3 wherein an opening (34) behind the flap (18) allows for the insertion of a hair dryer (32).

The bag (10) has an expandable cover (20) which is accessed by unzipping the main cover (22) so as to allow the expandable cover (20) to deploy. A plurality of elongated support members (15) can be used to give support and keep the expanded shape to the expandable cover (20). The elongated support members (15) are inserted into any one of a plurality of square openings (13) of the grid floor (12) and can also be inserted into each other to extend.

Other features such as small pockets (24) handle, (26), wheels (28), and a protractable handle (30) round up the features of the sports equipment bag (10).

When unzipping both the main cover (22) and the expandable cover (20) an access is created to put in or remove contents from the sports equipment bag (10).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A sports equipment bag comprising:
a flexible shell defining an environmentally controlled interior space having a bottom portion, side wall portions, and a top portion; an sealable opening within said top portion adapted to allow sports equipment to be placed within and taken out from said interior space; an opening within one of said side wall portions adapted to allow environmentally controlled air to be placed within and taken from said interior space; an opening cover attached adjacent to said side wall opening and adapted to cover and seal said side wall opening when not in use; a grid floor member attached to at least one of said side wall portions and suspended above said bottom portion forming a gap therebetween, and including a plurality of holes therein; and at least one elongated support member adapted to fit within any one of said holes of said grid floor member and is adapted to extend between said bottom portion and said top portion and thereby support said top portion.

2. The sports equipment bag of claim 1, wherein at least one of said side wall portions has an opening in proximity to said gap and is adapted to allow air and liquid to be removed from said interior space.

3. The sports equipment bag of claim 1, wherein at least two side wall portions include a bottom edge molding that is adapted to hold said grid floor member above said bottom portion.

4. The sports equipment bag of claim 1, wherein said top portion is formed as an expandable fabric member; and wherein there is a plurality of elongated support members, wherein each said elongated support member is adapted to be attached to another elongated support member in an end-to-end fashion thereby extending the length of each support member, such that when said top portion is expanded the elongated support members can also be extended and continue to support said top portion in the expanded position.

5. The sports equipment bag of claim 4, further comprising a pivotable main cover member pivotally connected along an edge of said top portion, such that when in use said main cover member can be pivoted into an open position and said top portion expanded upwards therefrom.

6. The sports equipment bag of claim 1, wherein said plurality holes of said grid floor member and said at least one elongated support member have a rectangular cross section, such that said elongated support member cannot rotate when installed within any one of said plurality holes.

7. The sports equipment bag of claim 1, further comprising an electric fan placed within said opening within one of said side wall portions, to thereby force environmentally controlled air into said interior space.

8. The sports equipment bag of claim 7, wherein said electric fan further includes a heating element and an elongated power cord.

9. The sports equipment bag of claim 7, wherein said electric fan further includes an ionic air purifier and an elongated power cord.

10. The sports equipment bag of claim 1, wherein said side wall opening cover is formed as a flexible flap.

11. The sports equipment bag of claim 1, wherein said grid floor member extends substantially over the entire surface defined by said bottom portion.

12. The sports equipment bag of claim 1, further including a thermostat attached thereto to monitor and control the interior temperature of said interior space.

13. The sports equipment bag of claim 1, further comprising at least one exterior pocket attached to an outer side wall of said side wall portions; each of said at least one pocket having a zipper member to open and enclose.

14. The sports equipment bag of claim 1, further comprising a flexible handle attached to an outer side wall of said side wall portions.

15. The sports equipment bag of claim 1, further comprising a retractable handle attached to an outer side wall of said side wall portions.

16. The sports equipment bag of claim 1, further comprising a plurality of wheels attached to an outer side wall of either of said side wall portions or said bottom portion.
